(19) United States
(12) Patent Application Publication
(10) Pub. No.: US 2004/0039589 A1
(43) Pub. Date: Feb. 26, 2004

(54) Method for providing management information and computer readable storage medium stored its program

(76) Inventor: Wan Soo Lee, Pembroke Pines, FL (US)

Correspondence Address: Peter T. Kwon, G W i P S, Kangnam P.O. Box 2301, Seoul, 135-242, KR

(21) Appl. No.: 10/414,097

(22) Filed: Apr. 16, 2003

(30) Foreign Application Priority Data
Jun. 12, 2002 (KR) 2002-0032816
Feb. 21, 2003 (KR) 2003-0010933

(51) Int. Cl. G06F 17/60

(52) U.S. Cl. 705/1; 705/7

(57) ABSTRACT

A method of providing management information under control of a central process unit (CPU) includes (a) displaying an option configuration window for configuring early warning and management information associated environments on a display unit; (b) storing option selection information including display warning option information and ticker setting information received from an input device in a storage medium; (c) displaying early warning information and management information from the DB server on the display unit using the option selection information; (d) displaying warning situation disposal information from the DB server on the display unit; and (e) displaying statistical information processed using the warning situation disposal information received from the DB server, on the display unit, wherein, at (c), the CPU transmits a request signal for sales information, purchasing information, stock information, production information, financial information, personnel information, marketing information, customer information, statistical information, or intellectual management information using a previously stored function option selection information, and receives corresponding information from the DB server in response to the request signal; the CPU displays the early warning information and management information received from the DB server on the display unit in the form of an ongoing ticker, a static ticker, or a full-screen display based on display warning option information and ticker setting information; and the CPU transmits detailed information of an item selected by the user to the display unit in the form of an instance massage so as to display the detailed information on the display unit when it is determined that the user intends to display the detailed information.

### BACKGROUND OF THE INVENTION

1. Field of the Invention

The present invention relates to a method for providing management information and computer-readable storage medium which is stored its program. More particularly, the management information and its computer program stored in the computer-readable storage medium are useful and effectively minimized the management risks by providing users with early warning information and management information during a predetermined period, or periodically, on a ticker display device or full-screen display without access to a database server.

2. Description of Related Prior Art

A publicly laid-opened Korean Patent Application No. 2000-0002428 discloses a management information-providing method and system that operates via a communication network.

In the prior art, the management information-providing method discloses the process steps of: implementing a server providing a management information system for at least one business field; determining whether a user trying to access the management information system has a previously given access right; and authorizing the user to access and operate the management information system.

However, the conventional management information-providing method and system has a drawback in that since it is not easy for a user unfamiliar with the computer operation environment to access the management information, the user may make a wrong decision for his/her business or fail to timely make an appropriate decision due to the lack of a warning service.

### SUMMARY OF THE INVENTION

It is an object of the present invention to provide a management information-providing method which is capable of providing early warning information and management information to a user, even one who is unfamiliar with the computer operation environment, such that the user can maximize utilization of the management information and quickly cope with an unexpected situation brought to light by the early warning information.

It is another object of the present invention to provide a management information-providing method which allows a plurality of users to share the early warning information and management information locally or globally.

To achieve the above objective, the management information early-warning method of the present invention includes (a) displaying, under control of a central process unit (CPU), an option configuration window for configuring early warning information and management information associated environments on a display unit; (b) storing, under control of the CPU, option selection information, including display warning option information and ticker setting information received from an input device in a storage medium; (c) displaying, under control of the CPU, early warning information and management information, on the display unit, received from the database (DB) server using the option selection information; (d) displaying, under control of the CPU, warning situation disposal information received from the DB server on the display unit; and (e) displaying, under control of the CPU, statistical information processed using the warning situation disposal information received from the DB server, on the display unit. At (c), the CPU transmits a request signal for sales information, purchasing information, stock information, production information, financial information, personnel information, marketing information, customer information, statistical information, or intellectual management information using previously stored function option selection information, and receives corresponding information from the DB server in response to the request signal; displays the early warning information and management information received from the DB server on the display unit in the form of an ongoing ticker, a static ticker, or full-screen display based on the display warning option information and the ticker setting information; and transmits detailed information of an item selected by the user to the display unit in the form of an instance massage so as to display the detailed information on the display unit when it is determined that the user intends to display the detailed information.

The management information early warning method of the present invention further comprises receiving, under control of the CPU, a transmission request signal from the input device for transmitting the early warning information and management information currently displayed on the display unit to other user computers; displaying, under control of the CPU, a transmission target computer status information window having a transmission target computer user ID display part, an on/off state display part for showing whether the transmission target computer is online or offline, a text box for inputting a message to be transmitted, and a button part with transmission and cancel buttons on the display unit so as to display the transmission target computer status information window; receiving, under control of the CPU, the transmission target computer selection signal and the message from the input device using the transmission target computer status information window; and transmitting, under control of the CPU, the currently displayed early warning information and management information display window to the DB server, together with the transmission target computer selection signal and the message.

The management information early warning method of the present invention further comprises receiving, under control of the CPU, a video conference request signal from the input device, for requesting a video conference related to the early warning information and management information currently displayed on the display unit with other users while sharing the early warning information and management information; displaying, under control of the CPU, a video conference target computer status information window having a conference target computer user ID display part, an on/off state display part for showing whether the conference target computer is online or offline, a text box for inputting message to be transmitted, and a button part with transmission and cancel buttons on the display unit so as to display the conference target computer status information window; receiving, under control of the CPU, the conference target computer selection signal and the message from the input device using the conference target computer status information window; and transmitting, under control of the CPU, a connection request signal to the DB server for requesting a connection to the computers of users who are to take part in the video conference; receiving, under control of the CPU, a connection establishment signal from the DB server in response to the connection request signal; and transmitting, under control of the CPU, users' video images inputted from the input device to the other computers participating in the video conference through the DB server, together with the early warning information and management information as well as the message currently displayed on the display unit.

Step (d) includes transmitting, under control of the CPU, information on action requesters, action receivers, action dates, and action results to the DB server; receiving, under control of the CPU, a summarized disposal information request signal for the warning situation from the input device; transmitting, under control of the CPU, a warning situation disposal information request signal to the DB server and receiving previously stored warning situation disposal information from the DB server;

Transmitting, under control of the CPU, summarized disposal information on the warning situation, including an MIS warning points column, an action requester column, an action receiver column, an action date column, and an action results column to the display unit so as to display such summarized disposal information regarding the warning situation; and transmitting, under control of the CPU, detailed information on a specific warning situation to the display unit so as to display detailed information on a specific warning situation when the CPU receives a display request signal for detailed information on one of the specific warning situation items listed in the MIS warning point column;

A computer-readable storage medium storing a program for providing management information according to the present invention, the program including the processes of (A) displaying, under control of a central processing unit (CPU), an option configuration window for configuring early warning information and management information associated environments on a display unit under control of the CPU; (B) storing, under control of the CPU, option selection information including display warning option information and ticker setting information received from an input device in a storage medium; (C) displaying, under control of the CPU, early warning information and management information received from the DB server on the display unit, using the option selection information; (D) displaying, under control of the CPU, warning situation disposal information received from the DB server on the display unit; and (E) displaying statistical information, processed using the warning situation disposal information received from the DB server, on the display unit,

At process (C), the CPU transmits a request signal for sales information, purchasing information, stock information, production information, financial information, personnel information, marketing information, customer information, statistical information, or intellectual management information using previously stored function option selection information, and receives corresponding information from the DB server in response to the request signal; displays the early warning information and management information received from the DB server on the display unit in the form of an ongoing ticker or a full-screen display based on the display warning option information and the ticker setting information; and transmits detailed information of an item selected by the user to the display unit in the form of an instance massage so as to display the detailed information on the display unit when it is determined that the user intends to display the detailed information.

The program further comprises the processes of receiving, under control of the CPU, a transmission request signal from the input device for transmitting the early warning information and management information currently displayed on the display unit to other user computers; displaying, under control of the CPU, a transmission target computer status information window having a transmission target computer user ID display part, an on/off state display part for showing whether the transmission target computer is online or offline, a text box for inputting a message to be transmitted, and a button part with transmission and cancel buttons on the display unit so as to display the transmission target computer status information window; receiving, under control of the CPU, the transmission target computer selection signal and the message from the input device using the transmission target computer status information window; and transmitting, under control of the CPU, the currently displayed early warning information and management information display window to the DB server, together with the transmission target computer selection signal and the message.

The program further comprises the processes of receiving, under control of the CPU, a video conference request signal, from the input device, for requesting a video conference related to the early warning information and management information currently displayed on the display unit with other users while sharing the early warning information and management information; displaying, under control of the CPU, a video conference target computer status information window having a conference target computer user ID display part, an on/off state display part for showing whether the conference target computer is online or offline, a text box for a inputting message to be transmitted, and a button part with transmission and cancel buttons on the display unit so as to display the conference target computer status information window; receiving, under control of the CPU, the conference target computer selection signal and the message from the input device using the conference target computer status information window; and transmitting, under control of the CPU, a connection request signal to the DB server for requesting a connection to the computers users who are to take part in the video conference; receiving, under control of the CPU, a connection establishment signal from the DB server in response to the connection request signal; and transmitting, under control of the CPU, users' video images inputted from the input device to the other computers participating in the video conference through the DB server, together with the early warning information and management information as well as the message currently displayed on the display unit.

Process (D) includes: transmitting, under control of the CPU, information on action requesters, action receivers, action dates, and action results to the DB server; receiving, under control of the CPU, a summarized disposal information request signal for the warning situation from the input device; transmitting, under control of the CPU, a warning situation disposal information request signal to the DB server and receiving previously stored warning situation disposal information from the DB server; transmitting, under control of the CPU, the summarized disposal information on the warning situation, including an MIS warning points column, an action requester column, an action receiver column, an action date column, and an action results column to the display unit so as to display the summarized disposal information on the warning situation; and transmitting, under control of the CPU, detailed information on a specific warning situation to the display unit so as to display detailed information on a specific warning situation when the CPU receives a display request signal for detailed information on one of the specific warning situation items listed in the MIS warning point column.

### BRIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1 is a block diagram illustrating a management information early warning system according to an embodiment of the present invention.

FIG. 2a is a flowchart illustrating a management information early warning method according to a preferred embodiment of the present invention.

FIG. 2b is an exemplary screenshot illustrating a function-setting interface of the option configuration window for the management information early warning method of FIG. 2a.

FIG. 2c is an exemplary screenshot illustrating a warning display setting interface of the option configuration window of FIG. 2b.

FIG. 2d is an exemplary screenshot illustrating a ticker-setting interface of the option configuration window of FIG. 2b.

FIG. 2e is an exemplary screenshot which represents, as a specific icon, a program operating the management information early warning method according to an embodiment of the present invention.

FIG. 2f is an exemplary view illustrating a summarized statistical information table according to an embodiment of the present invention.

FIG. 2g is an exemplary view illustrating a detailed statistical information-table according to an embodiment of the present invention.

FIG. 3a is a flowchart illustrating an early warning information and management information-providing procedure according to an embodiment of the present invention.

FIG. 3b is an exemplary screenshot illustrating a ticker display pane as part of a desktop in which early warning information and management information is scrolling, according to an embodiment of the present invention.

FIG. 3c is an exemplary screenshot illustrating a ticker display pane as part of a desktop in which early warning information is scrolling, according to an embodiment of the present invention.

FIG. 3d is an exemplary screenshot illustrating an early warning information and management information window in the form of a full desktop screen, according to an embodiment of the present invention.

FIG. 3e is an exemplary screenshot illustrating an early warning information and management information window in the form of an alternative full desktop screen, according to an embodiment of the present invention.

FIG. 3f is an exemplary screenshot illustrating a detailed information display window in the form of a full desktop screen, according to an embodiment of the present invention.

FIG. 3g is an exemplary screenshot illustrating another detailed information desktop window in the form of a full desktop screen, according to an embodiment of the present invention.

FIG. 3h is an exemplary screenshot illustrating a submenu for transmitting a display window represented on the desktop screen, according to an embodiment of the present invention.

FIG. 3i is an exemplary screenshot illustrating a display window presenting status information on a target computer to which the display window is transmitted.

FIG. 3j is an exemplary screenshot illustrating an incoming message announcement pane on the desktop of the target computer, according to an embodiment of the present invention.

FIG. 3k is an exemplary screenshot illustrating the display window on the desktop of the target computer, according to an embodiment of the present invention.

FIG. 3l is an exemplary screenshot illustrating a display window for presenting status information on a computer participating in a video conference, according to an embodiment of the present invention.

FIG. 3m is an exemplary screenshot illustrating a video conference window according to an embodiment of the present invention.

FIG. 4a is a flowchart illustrating a warning situation management information reception procedure according to an embodiment of the present invention.

FIG. 4b is an exemplary view illustrating a summarized warning situation table according to an embodiment of the present invention; and

FIG. 4c is an exemplary view illustrating a detailed warning situation table according to an embodiment of the present invention.

### DETAILED DESCRIPTION OF THE PREFERRED EMBODIMENTS

A preferred embodiment of the present invention will be described hereinafter with reference to the accompanying drawings.

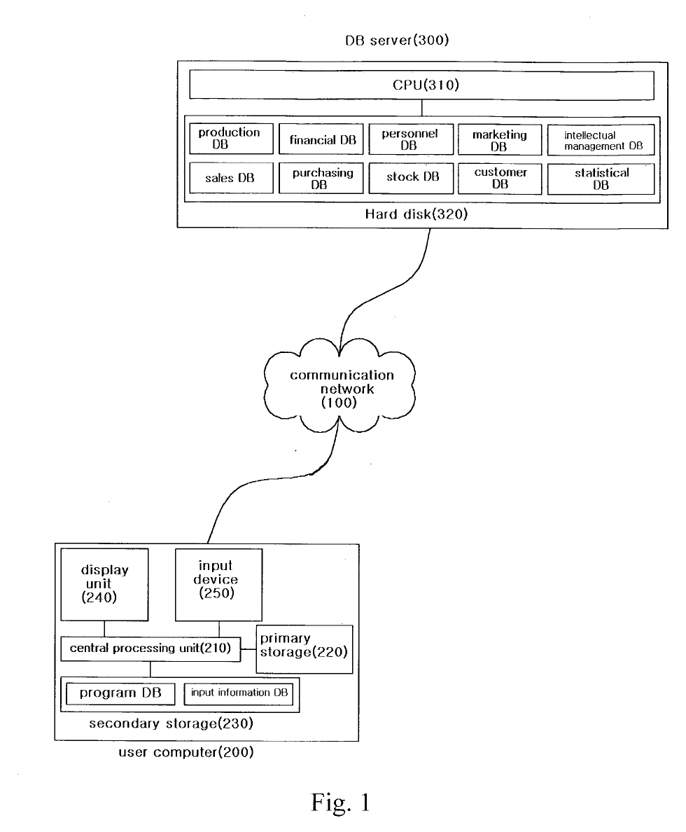

FIG. 1 is a block diagram illustrating a management information early warning system according to an embodiment of the present invention.

As shown in FIG. 1, the management information early warning system includes a communication network 100, at least one user computer 200, and a database (DB) server 300.

The communication network includes a wired Internet implemented with transmission control protocol/internet protocol (TCP/IP), wireless application protocol (WAP), and local area networks (LAN).

The user computer 200 is a communication-allowable device running Windows 98 or a higher-version Windows operating system, together with an Internet browser capable of displaying web pages. The user computer 200 can be a personal digital assistant (PDA) or an IMT-2000-based communication terminal, as well as a personal computer such as a desktop or notebook computer, that includes a central processing unit 210, primary storage 220, secondary storage 230, a display unit 240, and an input device (250).

The central processing unit 210 consists of a control unit and an arithmetic/logic unit with specific functions, and preferably is a Pentium or a processor of higher capability.

The primary storage 220 holds data and instructions for processing, and preferably has a storage capability of more than 64 Mb.

The secondary storage 230 stores a program DB with software for executing the method of the present invention, as well as an input data DB for storing information such as the configured option information inputted through the input device 250. The DBs are managed by a database management program.

In a preferred embodiment of the present invention, the data inputted through the input device 250 is stored and managed in the input data DB, but is not limited thereto, and the input data, user access rights, and selection information can be stored in the form of a file.

The display unit 240 outputs data according to the present invention, and can be a monitor or a speakerphone (not shown).

The input device 250 inputs various data according to the present invention, and can be a CD-ROM, a mouse, a keyboard, a microphone, or a digital camera (not shown).

The DB server 300 stores and manages data relating to a business, generates management information based on the data, and transmits the associated information to the user computer 200 in response to a request from the user computer 200. The DB server 300 includes a CPU 310 and a hard disc 320.

The CPU 310 is operated by an operation system that processes massive amounts of data, executes arithmetic calculations during data communication, and retrieves data from the database.

The hard disc 320 includes a sale management DB for storing a company's sale information; a purchase management DB for storing purchase information; a stock management DB for storing stock information; a production DB for storing information relating to products manufactured by the company; a financial DB for storing tax and account information; a personnel DB for storing personnel career information; a marketing DB for storing marketing strategy information; a customer DB for storing customer information; a statistics DB for storing static information associated with the sales information, purchasing information, stock information, production information, financial information, personnel information, marketing information, customer information, and intellectual management information; and an intellectual management DB for storing intellectual management information. The DBs are generated and managed by additional database management software.

While this invention has described the early warning information and management information transmitted to the user computer 200 from the respective DBs, the embodiment is not limited thereto, but includes data types such as a Raw Data type UNIX files or Remote Function Calls (RFCs) extracted by invoking a specific application function as well as the DB server.

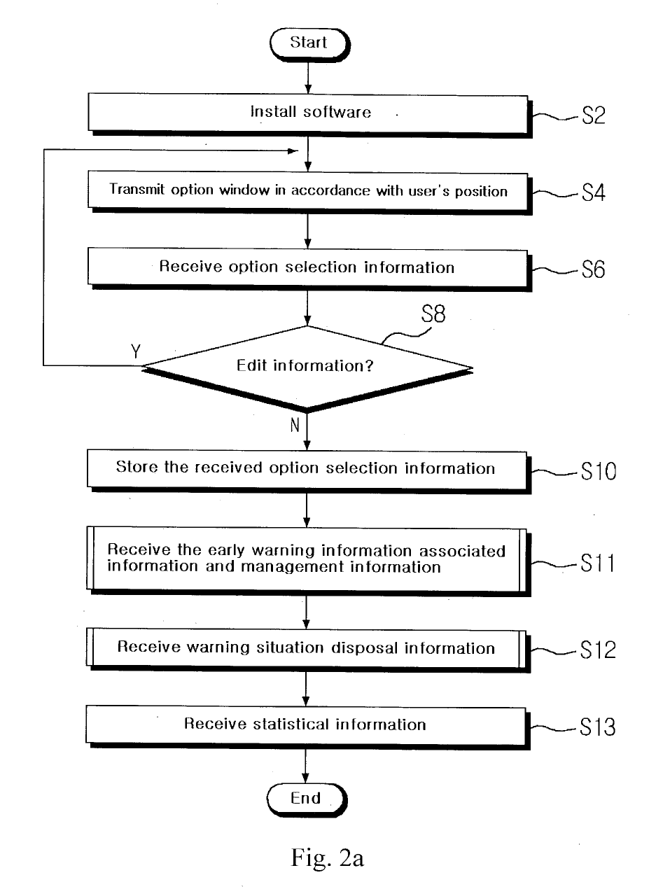

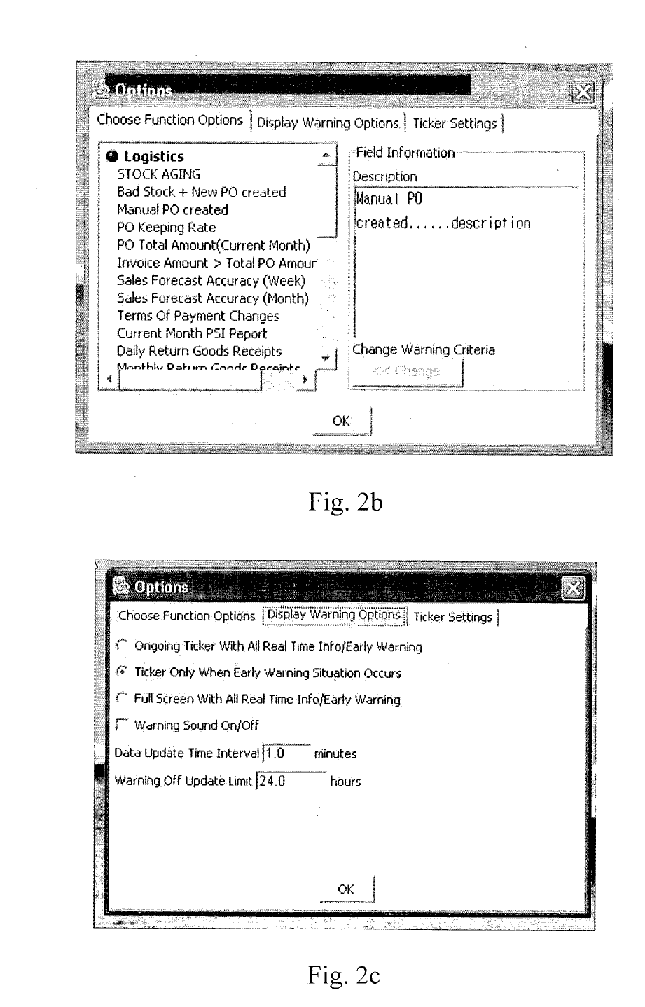

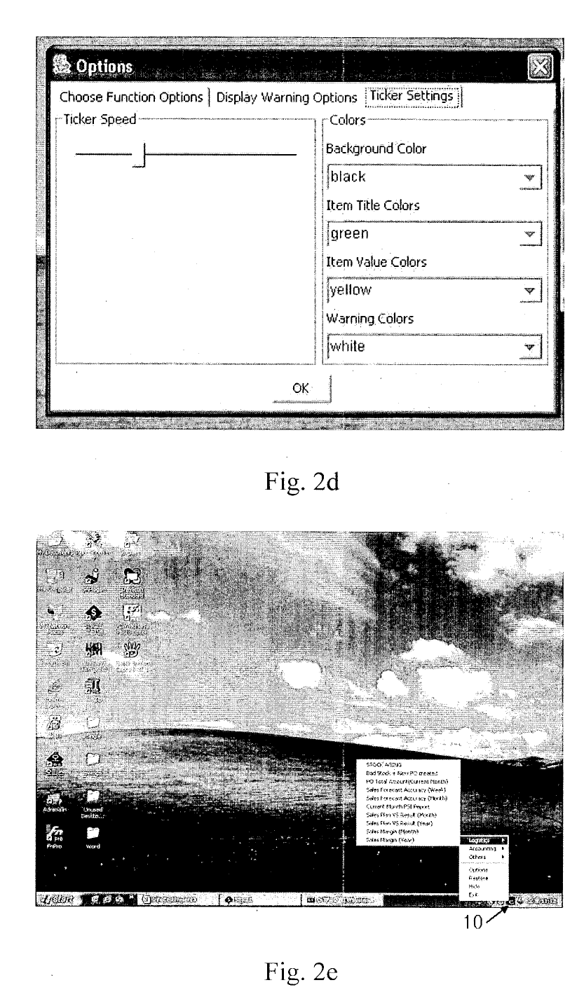

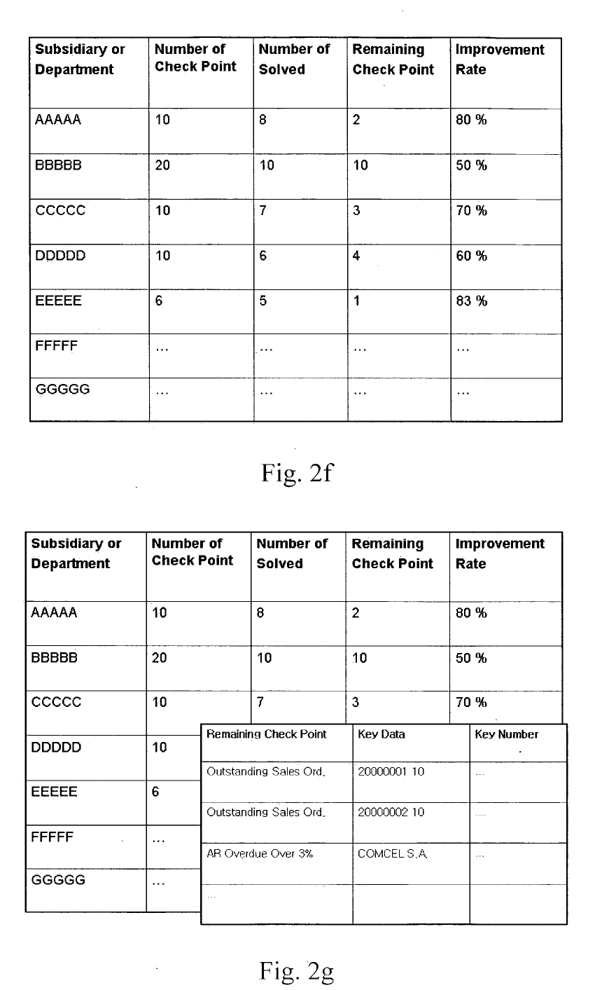

The management information early warning method according to the preferred embodiment of the present invention will be described hereinafter with reference to FIGS. 2a through 2g.

FIG. 2a is a flowchart illustrating the management information early warning method according to a preferred embodiment of the present invention; FIG. 2b is an exemplary screenshot illustrating a function setting interface of the option configuration window for the management information early warning method of FIG. 2a; FIG. 2c is an exemplary screenshot illustrating the warning display setting interface of the option configuration window of FIG. 2b; FIG. 2d is an exemplary screenshot illustrating the ticker setting interface of the option configuration window of FIG. 2b; FIG. 2e is an exemplary screenshot which represents a program, as a specific icon, operating the management information early warning method, according to an embodiment of the present invention; FIG. 2f is an exemplary view illustrating a summarized statistical information table according to an embodiment of the present invention; and FIG. 2g is an exemplary view illustrating a detailed statistical information-table according, to the embodiment of the present invention.

As shown in FIG. 2a, the central processing unit 210 receives information, including at least the position and name of a user, through CD ROM as the input device 250, and receives and stores the management information early warning software, according to an embodiment of the present invention, in the program DB so as to install the management information early warning software at step S2.

Even though the management information warning software is read and installed from the CD ROM in this embodiment, the present invention is not limited thereto.

Also, the user positions are classified into a chief executive management level, intermediate management level, manager, and working level, but the present invention is not limited thereto.

The central processing unit 210 controls the display unit 240, which in turn displays an option configuration window through which a user can configure the visual environment associated with the early warning information and management information using the user's position information inputted from the input device 250 at step S4.

The option configuration window includes a function options pane, a display warning options pane, and a ticker settings pane.

The function options pane provides a menu allowing the user to select early warning information and management information from the DB server 300, and comprises an early warning information and management information selection frame on the left side and an information display frame on the right side for displaying selected items, as shown in FIG. 2b.

In this embodiment, a statistical information display window is exemplarily depicted; the present invention is not limited thereto.

Also, the display warning options pane provides a display method selection menu with which a user may determine how the early warning information and management information is to be displayed on the display unit 240 of the user computer, and comprises radio buttons for selecting the display manner of the information on the display unit 240, such as an ongoing ticker with real-time information or an early warning ticker which displays information only when an early warning situation occurs, a full-screen display with real time information and early warning; a selection box for selecting the on/off state of a warning sound; a text box for setting a data update time interval for updating the data by periodically receiving the data from the DB server; and a text box for setting a warning-off update limit for downloading information on the unprocessed early warning situation when the DB server 300 does not receive the early warning situation information.

In this embodiment, when the display warning options are set in such a manner that that “the ticker only when early warning situation occurs” item is selected, the warning sound is off, the data update time interval is 1 minute, and the warning-off update limit is 24 hours however, the present invention is not limited thereto.

The ticker settings pane provides a menu for setting the ticker display conditions when the early warning information and management information is displayed in the form of ticker, and includes a scroll bar for adjusting the movement speed of the information in the ticker on the right side and several combo boxes for setting the visual environment of the ticker on the right side, as shown in FIG. 2d.

In this embodiment, the background color is set to black, the item title color is set to green, the item value color is set to yellow, and the warning color is set to white; however, the present invention is not limited thereto.

The central processing unit 210 receives the option selection information from the input device 250 through the option configuration window at step S6.

As described above, the option selection information includes the early warning information and management information that the user wants to receive through the computer 200; display warning options information selected among the “ongoing ticker with real-time information/early warning,” “ticker only when early warning situation occurs,” and “full-screen with all real-time information/early warning” items; the warning sound on/off associated information; the data update time interval information; and the warning-off update limit information.

The central processing unit 210 controls the display unit 240, which in turn displays a dialog window asking whether or not to edit the information inputted at step S6 and then determining whether or not the user intends to edit the information on the basis of the signal inputted from the input device 250.

If it is determined that the user wants to edit the inputted information at step S8, the central processing unit 210 returns the process to the step S4. On the other hand, if it is determined that the user does not want to edit the inputted information, the central processing unit 210 stores the option selection information inputted at step S6 in the input information DB at step S10.

If the computer 200 is rebooted after the central processing unit 210 stores the option selection information, the central processing unit 210 displays an icon 10 symbolizing the software on a task bar on the desktop screen, as shown in FIG. 2e, according to an embodiment of the present invention.

Once the user double-clicks the icon 10 using the input device 250, the central processing unit 210 executes the software so as to communicate the information with the DB server 300 such that the user can view the information in real-time through the display unit 240.

Alternatively, the information may be displayed on the display unit 240 when the user computer 200 is turned on.

The central processing unit 210 requests the early warning information and management information from the DB server 300 using the option selection information received at step S6, and then transmits the received option selection information to the display unit 240 to be displayed thereon at step S11.

The central processing unit 210 receives the warning situation disposal information from the DB server 300 and transmits the same to the display unit 240 such that the display unit 240 displays the warning situation disposal information at step S12.

The DB server 300 statistically analyzes checkpoint times, processing times, remaining checkpoint times, and modification rate relating to the early warning information and management information, and stores the results in the statistics DB after a predetermined period of time has lapsed, and the central processing unit 210 transmits the statistical information request to the DB server 300 so as to receive the statistical information and transmit at least some of it to the display unit 240 in order for the display unit to display the information at step S13 (see FIG. 2f and FIG. 2g).

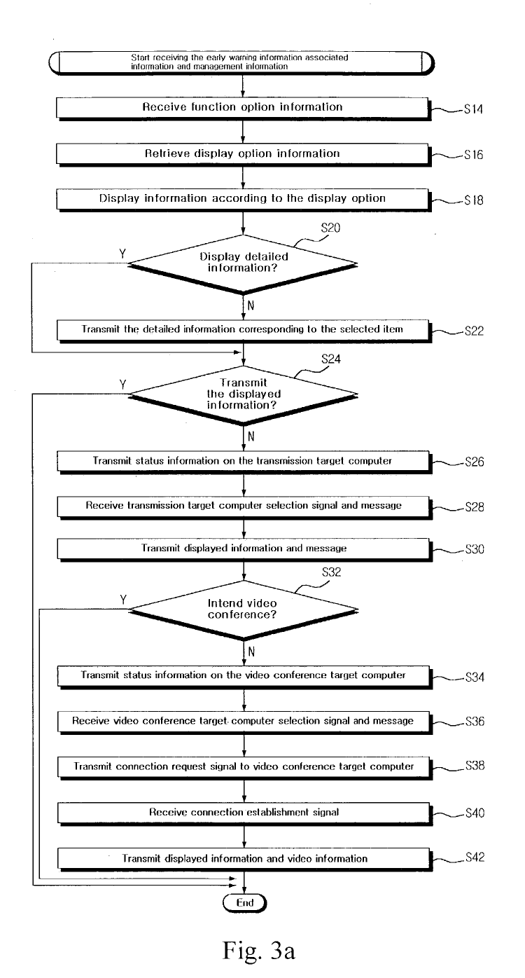

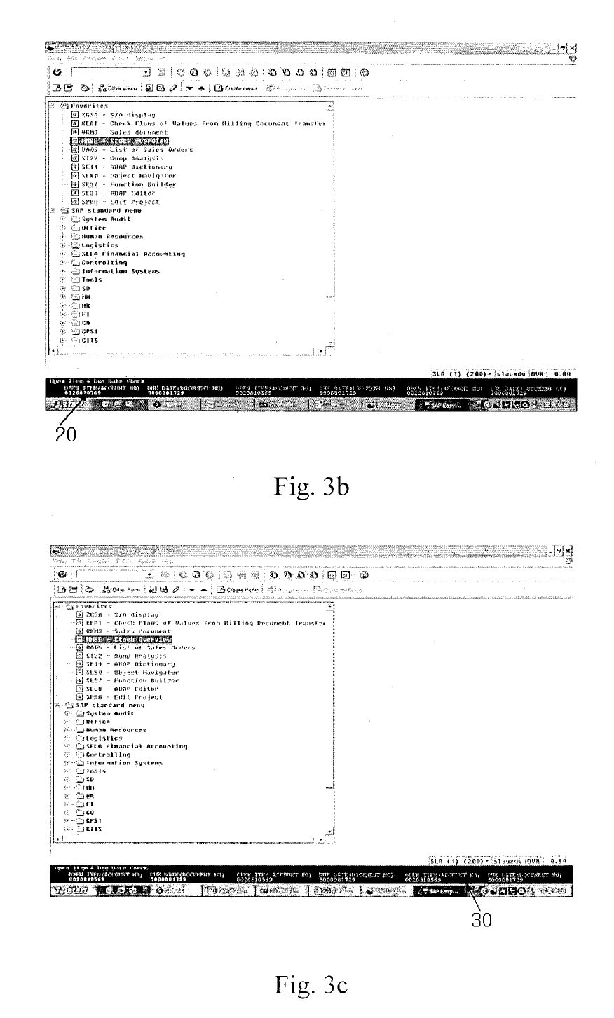

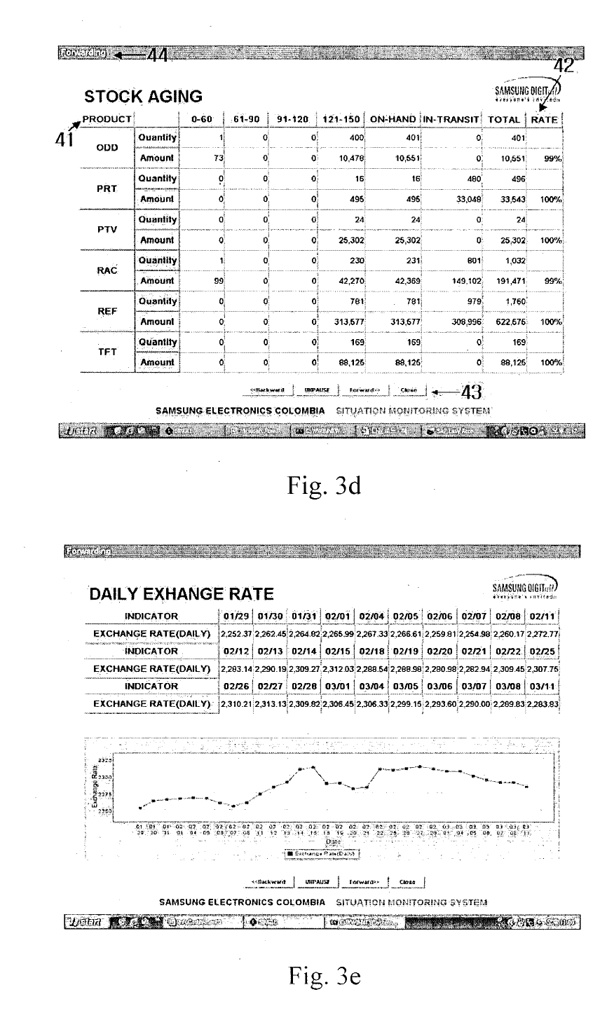

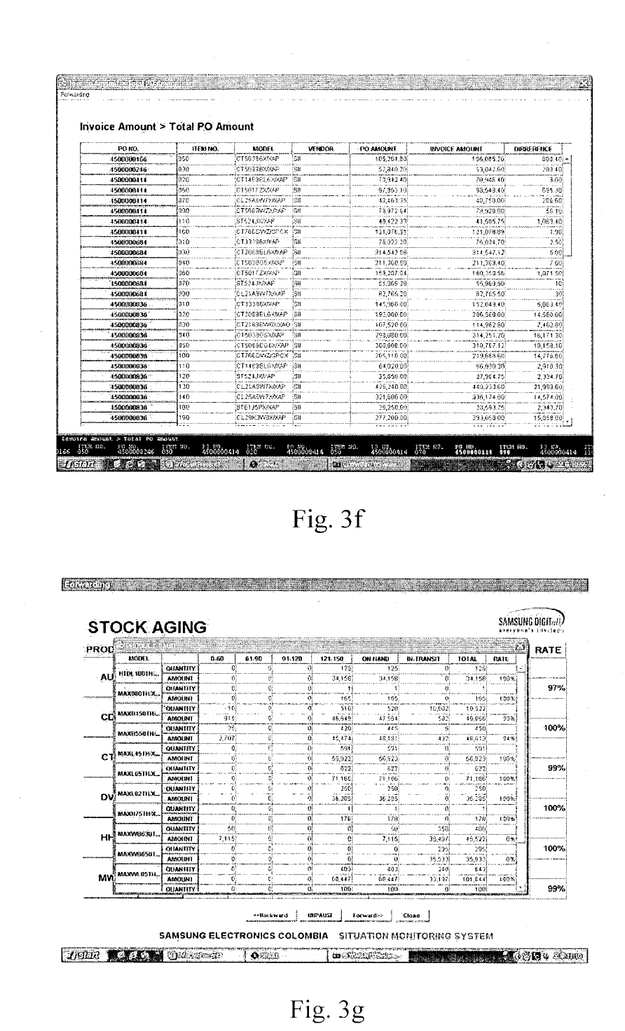

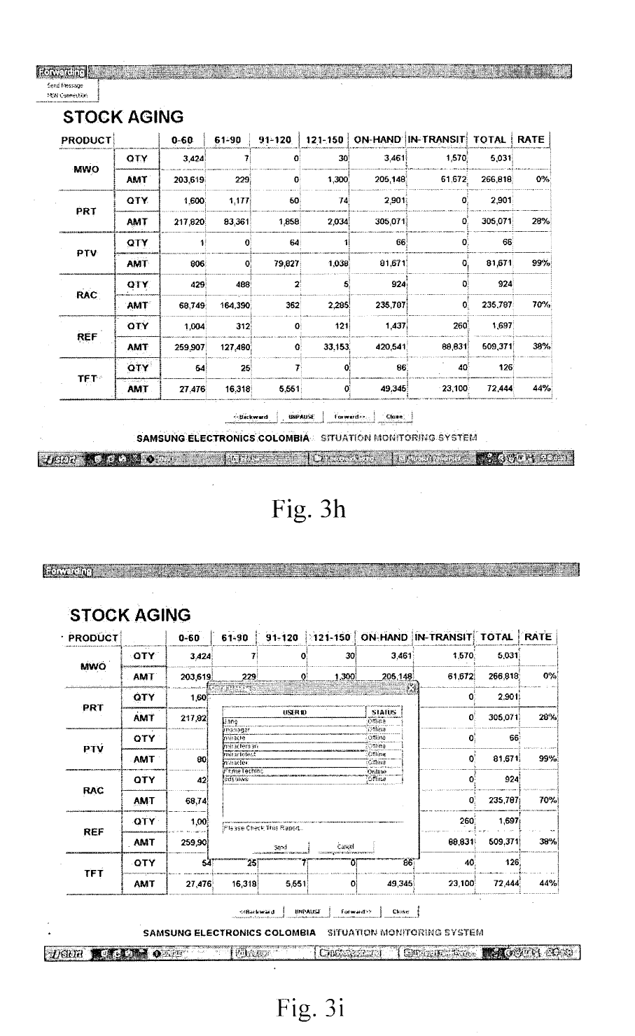

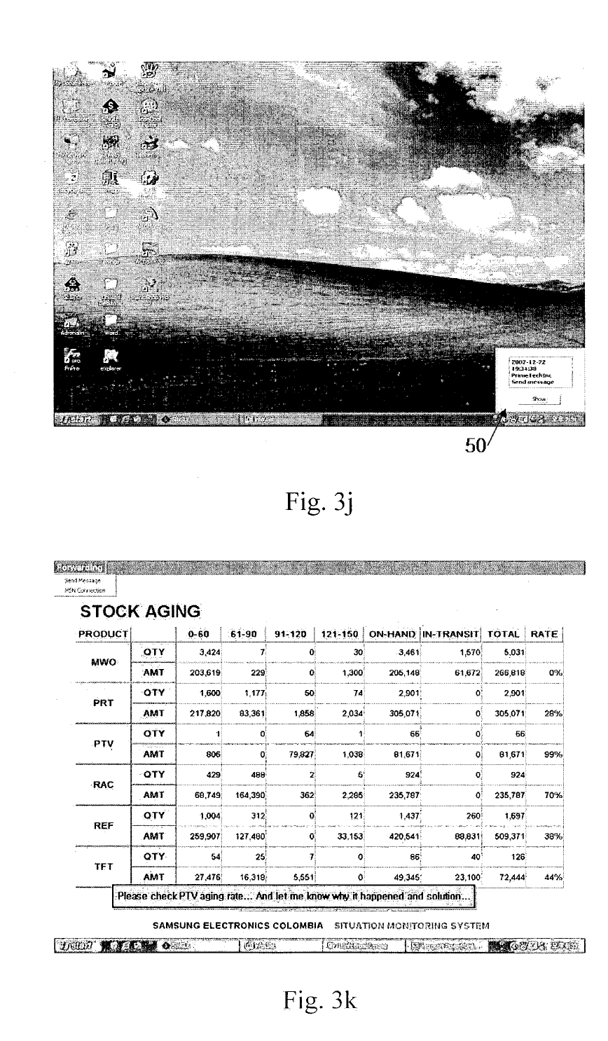

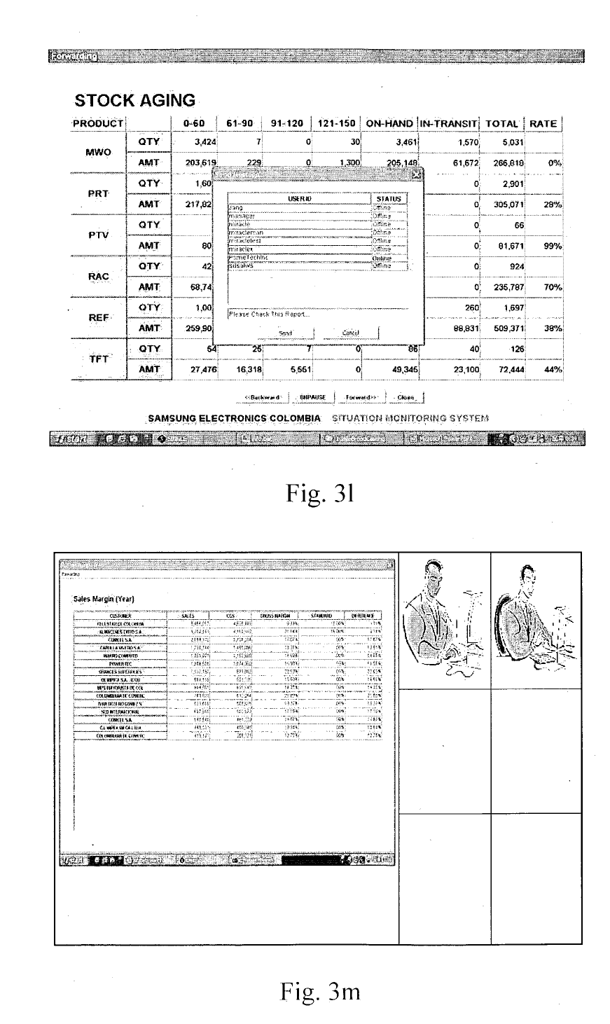

The early warning information and management information provided at step S11 will be described hereinafter in more detail with reference to FIGS. 3a through 3m.

FIG. 3a is a flowchart illustrating an early warning information and management information-providing procedure according to an embodiment of the present invention; FIG. 3b is an exemplary screenshot illustrating a ticker display pane as part of a desktop in which early warning information and management information scrolls, according to an embodiment of the present invention; FIG. 3c is an exemplary screenshot illustrating a ticker display pane as part of a desktop in which early warning information scrolls, according to an embodiment of the present invention; FIG. 3d is an exemplary screenshot illustrating an early warning information and management information window in the form of a full desktop screen, according to an embodiment of the present invention; FIG. 3e is an exemplary screenshot illustrating an early warning information and management information window in the form of an alternative full desktop screen, according to an embodiment of the present invention; FIG. 3f is an exemplary screenshot illustrating a detailed information display window in the form of a full desktop screen, according to an embodiment of the present invention; FIG. 3g is an exemplary screenshot illustrating another detailed information desktop window in the form of a full desktop screen, according to an embodiment of the present invention; FIG. 3h is an exemplary screenshot illustrating a submenu for transmitting a display window represented on the desktop screen, according to an embodiment of the present invention; FIG. 3i is an exemplary screenshot illustrating a display window presenting status information on a target computer to which the display window is transmitted; FIG. 3j is an exemplary screenshot illustrating an incoming message announcement pane on the desktop of the target computer, according to an embodiment of the present invention; FIG. 3k is an exemplary screenshot illustrating a display window displayed on the desktop of the target computer, according to an embodiment of the present invention; FIG. 3l is an exemplary screenshot illustrating a display window presenting status information on a computer participating in a video conference, according to an embodiment of the present invention; and FIG. 3m is an exemplary screenshot illustrating a video conference window, according to an embodiment of the present invention.

As shown in FIG. 3a, the central processing unit 210 transmits a request signal for sales information, purchasing information, stock information, production information, financial information, personnel-information, marketing information, customer information, statistical information, or intellectual management information to the DB server 300, and receives the early warning information and management information from the DB server 300 through the communication network 100 using the previously stored function option selection information.

The central processing unit 210 is set so as to receive all of the early warning information and management information requested by the user using the function option information of the option selection information previously stored in the input information DB in this embodiment; however, the present invention is not restricted thereto, and it is possible that the central processing unit 210 transmits all of the option selection information, such as function option information, display warning option information and ticker settings information, to the DB server 300 and receives information corresponding to all of the option selection information from the DB server 300.

The central processing unit 210 retrieves the display warning option information, and ticker settings information, and previously stored input information from the DB, and determines in which form, to display the received early warning information and management information on the display unit 240 at step S16.

The central processing unit 210 controls the result such that the display unit displays the early warning information and management information received from the DB server 300 at step S14 in the ongoing ticker, the static ticker, or the full-screen form at step S18.

In this embodiment, the ongoing ticker 20 is located at the bottom of the desktop screen, as shown in FIG. 3b, and the early warning information and management information scrolls from left to right in the ticker according to the ticker setting option information received at the step S6; however, the present invention is not limited thereto.

Also, as shown in FIG. 3c, the ticker 30 is located at the bottom of the desktop screen. The early warning information flickers in the ticker 30, and a warning sound is outputted according to the ticker setting option information received at step S6. Thus, this method differs from the ongoing ticker method.

That is, in the ticker type display method, the information to be displayed is restricted to information associated to the warning situation, whereas with the ongoing ticker method, information relating to the warning situation, as well management information is displayed.

In the full-screen type display method, as shown in FIG. 3d, information relating to the warning situation, as well as management information, are displayed on the full screen of the desktop.

As shown in FIG. 3d, the display window for the early warning information and management information in the full-screen type display method, according to the preferred embodiment, includes a product item column 41, an early warning associated rate column 42, a function selection button part 43, and a forwarding menu part 44.

The product item column 41 displays a plurality of product items such that if the user selects one of the items using the mouse of the input device 250, the central processing unit 210 recognizes the signal inputted by the mouse and displays the detailed information associated with the selected item.

Also, information characters displayed on each item of the early warning associated rate column 42 flicker.

Also, the function selection button part 43 includes several buttons for selecting functions such as moving and displaying other information display windows, locking the current display window, and closing a display window.

The forwarding menu part 44 includes a send message submenu for sending the early warning information and management information displayed on the current display window to another user computer and a video/audio conference submenu for performing a video/audio conference when the user wants to have a video/audio conference in association with the early warning information and management information displayed on the current display window.

In this embodiment, the full-screen type display window is set as shown in FIG. 3d; however, the present invention is not limited thereto. Based on the kind of information to be displayed, the display window includes a graph associated with the information, as shown in FIG. 3e.

The CPU 310 checks whether or not a selection signal for the item number or product is inputted from the input device 250 so as to determines whether or not the user intends to display detailed information associated to the currently displayed early warning information and management information on the display unit 240 at step S20.

As a result of step S29, if it is determined that the user intends to display detailed information associated with the currently displayed early warning information and management information on the display unit 240, the CPU 310 transmits the detailed information associated with the selected item to the display unit 240 and displays the detailed information, as shown in FIG. 3f or FIG. 3g.

FIG. 3f is an exemplary view of a display window, in the form of a ticker, on which detailed early warning information and management information associated with an item number, as selected by the user using the input device 250 on the current display window, is displayed; and FIG. 3g is an exemplary view of display window on which the detailed information associated with a selected product item is displayed when the user selects a product item using the input device 250 on the current display window.

As shown in FIG. 3h, the CPU 310 checks whether or not a signal for selecting the send message submenu of the forwarding menu is inputted by the input device so as to determine whether or not the user intends to transmit the early warning information and management information displayed on the current display window to other user computers at step S24.

As a result of step S24, the central processing unit 210 ends the system associated with the early warning information and management information reception step, according to the preferred embodiment of the present invention, if it is determined that the user does not intend to transmit the early warning information and management information. Also, the central processing unit 210 transmits a window displaying status information of transmission target computers to the display unit so as to display the status information thereon, as shown in FIG. 3i, if it is determined that the user intends to transmit the early warning information and management information, at step S26.

As shown in FIG. 3i, the transmission target computer status information display window includes a transmission target computer user id indicator, an on/off status indicator for indicating whether or not the transmission target computers are online or offline, a text box for inputting a short message to be transmitted with the early warning information and management information, and a button part having transmit and cancel buttons.

If the user selects a transmission target computer and/or inputs a short message in the text box using the input device 250 on the display window of FIG. 3i, the central processing unit 210 receives a transmission target computer selection signal and a short message at step S28.

The central processing unit 210 transmits the current display window displaying the early warning information and management information to the DB server 300, together with the transmission target computer selection signal and the short message at step S30.

The DB server 300 receives the display window displaying the early warning information and management information displayed on the user computer 200, together with the transmission target computer selection signal and the short message from the central processing unit 210, and transmits the display window, including the early warning information and management information, and the short message, to the transmission target computer.

The transmission target computer receives the display window, including the early warning information and management information displayed on the user computer 200, together with the short message, and displays an incoming announcement message indicator 50, including a reception confirm button, on the desktop of the monitor of the transmission target computer, as shown in FIG. 3j.

If the user of the transmission target computer selects the reception confirm button of the incoming announcement message indicator 50 using the input device of the transmission target computer, the transmission target computer displays the received display window on the display unit, as shown in FIG. 3k.

As shown in FIG. 3k, the display window displayed on the transmission target computer includes an early warning information and management information display part for displaying the early warning information and management information displayed on the display unit 240 of the user computer, and a short message display part for displaying the short message inputted by the user.

The CPU 310 checks whether or not the signal for selecting the video/audio conference submenu of the forwarding menu is inputted from the input device 250 so as to determine whether or not the user intends to have a video/audio conference with other users in association with the early warning information and management information displayed on the display window at step S32.

As a result of step S32, the central processing unit 210 ends the system associated with the early warning information and management information reception step, according to the preferred embodiment invention, if it is determined that the user does not intend to have a video/audio conference, and the central processing unit 210 transmits a video/audio conference target computer status information window to the display unit 240 so as to display the video/audio conference target computer status thereon, as shown in FIG. 3l, if it is determined that the user intends to have the video/audio conference, at step S34.

As shown in FIG. 3l, the video/audio conference target computer status information window includes a video/audio conference target computer ID indicator, an on/off status indicator for indicating whether or not the video/audio conference target computers are online or offline, a text box for inputting a short message to be transmitted, and a button part having transmit and cancel buttons.

If the user selects a video/audio conference target computer and/or inputs a short message in the text box using the input device 250 on the display window of FIG. 3j, the central processing unit 210 receives a video/audio conference target computer selection signal and the short message at step S36.

The central processing unit 210 transmits a connection request signal to the DB server 300 for establishing a connection with another user computer for a video/audio conference at step S38.

The central processing unit 210 receives a connection establishment signal from the DB server 300 in response to the connection request signal at step S40.

The central processing unit 210 transmits the early warning information and management information, the short message inputted in the text box, and the video information of the user inputted from the input device 250 to the video/audio conference target computer to which the computer is connected through the DB server.

The early warning information and management information, the short message, and the video information are displayed on the monitor of the connected video/audio conference target computer, as shown in FIG. 3m.

As shown in FIG. 3m, the video/audio conference window, according to the preferred embodiment of the present invention, includes an early warning information and management information display part on the right side thereon and a video display part on the right side thereon for displaying images of users participating in the conference.

In this embodiment, the videoconference window is set such that two users may participate in the videoconference. However, the present invention is not limited thereto; it is possible that a plurality of users may participate in video conference.

As a result of step S20, if it is determined that a user does not intend to display detailed information, the CPU 310 performs step S240.

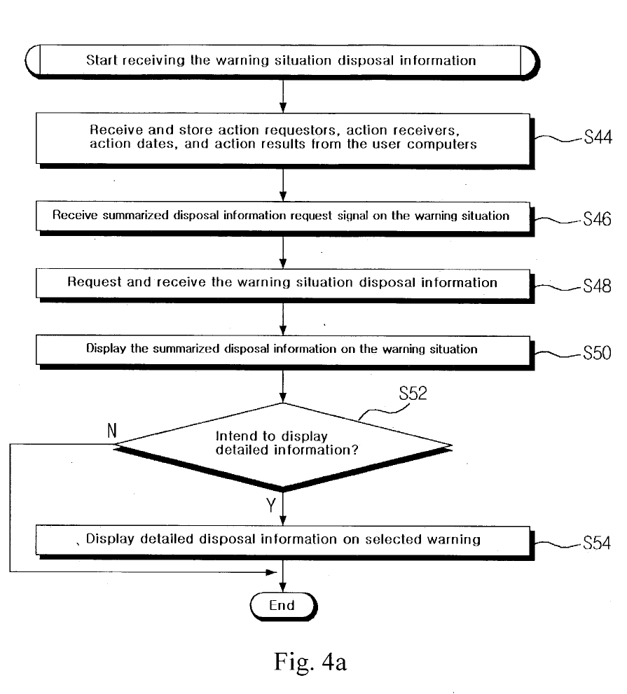

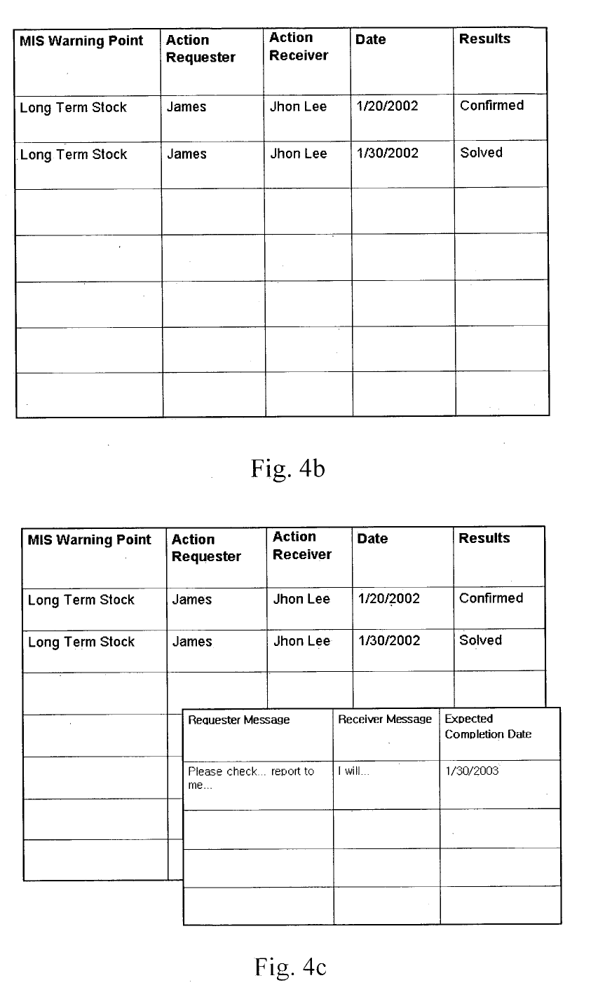

The warning situation disposal information reception step of S12 in FIG. 2a will be described hereinafter with reference to FIGS. 4 through 4c.

FIG. 4a is a flowchart illustrating a warning situation disposal information reception procedure according to an embodiment of the present invention; FIG. 4b is an exemplary view illustrating a summarized warning situation table according to an embodiment of the present invention; and FIG. 4c is an exemplary view illustrating a detailed warning situation table according to an embodiment of the present invention.

The DB server 300 receives information on action requesters, action receivers, action dates, and action results from user computers 200, and stores the information at step S44.

The central processing unit 210 receives summarized disposal information request signals from the input device 250 at step S46.

The central processing unit 210 transmits a warning situation disposal information request signal to the DB server 300, and receives warning situation disposal information in response to the warning situation disposal information request signal at step S48.

The central processing unit 210 transmits summarized disposal information on the warning situation to the display unit 240 using the table of FIG. 4b so as to display the summarized disposal information on the display unit 240 at step S50.

As shown in FIG. 4b, the summarized warning situation disposal information table, according to the preferred embodiment of the present invention, includes an MIS warning points column, an action requester column, an action receiver column, an action date column, and an action results column.

The MIS warning point column is configured such that detailed information associated with an item is displayed when the user select one of the items listed on the MIS warning point column by double clicking the same using the mouse of the input device 250.

The central processing unit 210 checks whether or not the user double-clicks one of the items on the MIS warning point items so as to determines whether or not the user intends to display the detailed information associated with the selected item on the display unit 240 at step S52.

As a result of the step S52, the central processing unit 210 ends the system associated with the disposal information reception step, according to the preferred embodiment of the present invention, if it is determined that the user does not want to display the detailed information, and the central processing unit 210 transmits the detailed information of the selected item to the display unit 240 using the warning situation detailed disposal information display window (see FIG. 4c), according to the preferred embodiment of the present invention, so as to display thereon, at step S54, if it is determined that the user intends to display the detailed information.

The present invention can be implemented with codes stored in a computer-readable storage medium. The computer-readable storage medium can be any kind of media in which the data stored therein can be read by the computer system. The storage media can be a ROM, RAM, CD FOM, magnetic tape, floppy disk, optical data storage device, etc. Also, the data can be received through the Internet in the form of a carrier wave. Also, the computer-readable storage media can be located at distributed computer systems connected through the network such that the computer-readable codes are stored in those computer systems.

As described above, the present invention provides users, especially those who are unfamiliar with how to access a DB server, and administrators, especially those who are unfamiliar with the management of information through the complex business system access and menus, with early warning information and management information, together with sound effects, such that such users and administrators may cope with early warning situations and improve management information utilization.

Also, according to the present invention, disposal contents and statistical information relating to early warning information and management information are shared by a plurality of members having system access authorization.

What is claimed is:

1. A management information early warning method using a management information early warning system includes user computers and a DB server connected through a communication network, the method comprises steps of:
(a) displaying, under control of a central processing unit (CPU), an option configuration window for configuring early warning and management information associated environments on a display unit;
(b) storing, under control of the CPU, option selection information including display warning option information and ticker setting information received from an input device in a storage medium;
(c) displaying, under control of the CPU, early warning information and management information from the DB server on the display unit using the option selection information;
(d) displaying, under control of the CPU, warning situation disposal information received from the DB server on the display unit; and
(e) displaying, under control of the CPU, statistical information processed using the warning situation disposal information received from the DB server, on the display unit,
wherein, at third step (c), the CPU transmits a request signal for sales information, purchasing information, stock information, production information, financial information, personnel information, marketing information, customer information, statistical information, or intellectual management information using previously stored, function option selection information; and receives corresponding information from the DB server in response to the request signal;
the CPU displays early warning information and management information received from the DB server on the display unit in the form of an ongoing ticket, a static ticker, or a full-screen display based on display warning option information and ticker setting information; and
the CPU transmits detailed information of an item selected by the user to the display unit in a form of an instance massage so as to display the detailed information on the display unit when it is determined that the user intends to display the detailed information.

2. The method as claimed in claim 1, further comprises steps of:
receiving, under control of the CPU, a transmission request signal from the input device for transmitting the early warning information and management information currently displayed on the display unit to another user computer;
displaying, under control of the CPU, a transmission target computer status information window having a transmission target computer user ID display part, an on/off state display part for showing whether the transmission target computer is online or offline, a text box for inputting message to be transmitted, and a button part with transmission and cancel buttons on the display unit so as to display the transmission target computer status information window;
receiving, under control of the CPU, the transmission target computer selection signal and the message from the input device using the transmission target computer status information window; and
transmitting, under control of the CPU, the currently displayed early warning information and management information display window to the DB server, together with the transmission target computer selection signal and the message.

3. The method as claimed in claim 1, further comprises steps of:
receiving, under control of the CPU, a video conference request signal, from the input device, for having a video conference related to the early warning information and management information currently displayed on the display unit with other users while sharing the early warning information and management information;
displaying, under control of the CPU, a video conference target computer status information window having a conference target computer user ID display part, an on/off state display part for showing whether the conference target computer is online or offline, a text box for a inputting message to be transmitted, and a button part with transmission and cancel buttons on the display unit so as to display the conference target computer status information window;
receiving, under control of the CPU, the conference target computer selection signal and the message from the input device using the conference target computer status information window; and
transmitting, under control of the CPU, a connection request signal to the DB server for requesting a connection to the computers of users who want to participate in the video conference;
receiving, under control of the CPU, a connection establishment signal from the DB server in response to the connection request signal; and
transmitting, under control of the CPU, users' video images inputted from the input device to the other computers participating in the video conference through the DB server, together with the early warning information and management information and the message currently displayed on the display unit.

4. The method as claimed in claim 1 wherein forth step (d) includes:
transmitting, under control of the CPU, information on action requesters, action receivers, action dates, and action results to the DB server;
receiving, under control of the CPU, a summarized disposal information request signal for the warning situation from the input device;
transmitting, under control of the CPU, a warning situation disposal information request signal to the DB server and receiving previously stored warning situation disposal information from the DB server;
transmitting, under control of the CPU, summarized disposal information on the warning situation including an MIS warning points column, an action requester column, an action receiver column, an action date column, and an action results column to the display unit so as to display summarized disposal information relating to the warning situation; and
transmitting, under control of the CPU, detailed information on a specific warning situation to the display unit so as to display detailed information on a specific warning situation when the CPU receives a display request signal for detailed information relating to a specific warning situation item listed the MIS warning point column.

5. A computer-readable storage medium storing a program for providing management information, the process program includes steps of:
(a) displaying, under control of a central processing unit (CPU), an option configuration window for configuring early warning and management information associated environments on a display unit under the control of a central processing unit (CPU);
(b) storing, under control of the CPU, option selection information including display warning option information and ticker setting information received from an input device in a storage medium;
(c) displaying, under control of the CPU, early warning information and management information from the DB server on the display unit using option selection information;
(d) displaying, under control of the CPU, warning situation disposal information received from the DB server on the display unit; and
(e) displaying statistical information processed using warning situation disposal information received from the DB server, on the display unit,
wherein, at third step (c), the CPU transmits a request signal for sales information, purchasing information, stock information, production information, financial information, personnel information, marketing information, customer information, statistical information, or intellectual management information using previously stored function option selection information, and receives corresponding information from the DB server in response to the request signal;
the CPU displays the early warning information and management information received from the DB server on the display unit in the form of an ongoing ticker, a static ticker, or a full-screen display based on display warning option information and ticker setting information; and
the CPU transmits detailed information of an item selected by the user to the display unit in the form of an instance massage so as to display the detailed information on the display unit when it is determined that the user intends to display the detailed information.

6. The computer-readable storage medium as claimed in claim 5, wherein the process program further comprises steps of:
receiving, under control of the CPU, a transmission request signal from the input device for transmitting early warning information and management information currently displayed on the display unit to another user computer;
displaying, under control of the CPU, a transmission target computer status information window having a transmission target computer user ID display part, an on/off state display part for showing whether the transmission target computer is online or offline, a text box for inputting a message to be transmitted, and a button part with transmission and cancel buttons on the display unit so as to display the transmission target computer status information window;
receiving, under control of the CPU, the transmission target computer selection signal and the message from the input device using the transmission target computer status information window; and
transmitting, under control of the CPU, the currently displayed early warning information and management information display window to the DB server, together with the transmission target computer selection signal and the message.

7. The computer-readable storage medium as claimed in claim 5, wherein the process program further comprises the steps of:
receiving, under control of the CPU, a video conference request signal from the input device for having a video conference related to the early warning information and management information currently displayed on the display unit with other users while sharing the early warning information and management information;
displaying, under control of the CPU, a video conference target computer status information window having a conference target computer user ID display part, an on/off state display part for showing whether the conference target computer is online or offline, a text box for inputting a message to be transmitted, and a button part with transmission and cancel buttons on the display unit so as to display the conference target computer status information window;
receiving, under control of the CPU, the conference target computer selection signal and the message from the input device using the conference target computer status information window; and
transmitting, under control of the CPU, a connection request signal to the DB server for requesting a connection to the computers of users who want to participate in a videoconference;
receiving, under control of the CPU, a connection establishment signal from the DB server in response to the connection request signal; and
transmitting, under control of the CPU, users' video images inputted from the input device to the other computers participating in the video conference through the DB server, together with early warning information and management information and the message currently displayed on the display unit.

8. The computer-readable storage medium as claimed in claim 5, wherein forth step (d) includes:
transmitting, under control of the CPU, information on action requesters, action receivers, action dates, and action results to the DB server;
receiving, under control of the CPU, a summarized disposal information request signal for a warning situation from the input device;
transmitting, under control of the CPU, a warning situation disposal information request signal to the DB server and receiving previously stored warning situation disposal information from the DB server;
transmitting, under control of the CPU, summarized disposal information on a warning situation, including an MIS warning points column, an action requester column, an action receiver column, an action date column, and an action results column to the display unit so as to display summarized disposal information on the warning situation; and
transmitting, under control of the CPU, detailed information relating to a specific warning situation to the display unit so as to display detailed information relating to a specific warning situation when the CPU receives a display request signal for detailed information relating to a specific warning situation item listed in the MIS warning point column.
